(19) United States
(12) Patent Application Publication
(10) Pub. No.: US 2022/0335698 A1
(43) Pub. Date: Oct. 20, 2022

(54) SYSTEM AND METHOD FOR TRANSFORMING MAPPING INFORMATION TO AN ILLUSTRATED MAP

(71) Applicant: Ashley SinHee KIM, Centreville, VA (US)

(72) Inventor: Ashley SinHee KIM, Centreville, VA (US)

(21) Appl. No.: 17/851,920

(22) Filed: Jun. 28, 2022

Related U.S. Application Data
(63) Continuation-in-part of application No. 17/126,001, filed on Dec. 17, 2020.
(60) Provisional application No. 62/949,427, filed on Dec. 17, 2019.

(51) Int. Cl. G06T 19/00; G02B 27/01; G06T 15/10

(52) U.S. Cl. CPC G06T 19/006; G02B 27/0103; G06T 15/10

(57) ABSTRACT

An approach for generating an illustrated digital map is disclosed. The approach comprises receiving map information specifying a plurality of points of interest. The approach further comprises retrieving characteristic information of the plurality of points of interest. The approach further comprises generating one or more icons representing the plurality of points of interest based on the characteristic information, wherein the one or more icons are illustrated images. The approach also comprises creating an illustrated digital map including the illustrated images, wherein the illustrated digital map is scaled to highlight the one or more icons and to factor in display size of a device. The approach further comprises presenting the illustrated digital map via a graphical user interface.

### RELATED APPLICATIONS

This application is a continuation-in-part of U.S. patent application Ser. No. 17/126,001, entitled “WORLDWIDE DRAWN GUIDE DIRECTORY,” filed Dec. 17, 2020, which is incorporated herein by reference in its entirety.

### BACKGROUND

Advances in navigation and mapping technologies have resulted in high reliance by users around the world to use a readily accessible map to locate points of interests. The prevalence and convenience of such mapping information is undeniable; this information is integral to devices and applications for navigation and directories. However, because certain devices, e.g., smart phones, possess a relatively small form factor, highlighting such points of interests can be challenging. Because maps are highly detailed with respect to every road, intersections, signs, buildings, homes, etc., they do not convey information efficiently. That is, the user may be recognize vital information quickly among the voluminous extraneous details.

### SOME EXAMPLE EMBODIMENTS

Therefore, there is a need for an approach that efficiently presents points of interests within a map or directory, particularly when the display size is a constraint.

According to one embodiment, a method comprises receiving map information specifying a plurality of points of interest. The method further comprises retrieving characteristic information of the plurality of points of interest. The method further comprises generating one or more icons representing the plurality of points of interest based on the characteristic information, wherein the one or more icons are illustrated images. The method also comprises creating an illustrated digital map including the illustrated images, wherein the illustrated digital map is scaled to highlight the one or more icons and to factor in display size of a device. The method further comprises presenting the illustrated digital map via a graphical user interface.

According to another embodiment, an apparatus comprises at least one processor, and at least one memory including computer program code for one or more computer programs, the at least one memory and the computer program code configured to, with the at least one processor, cause, at least in part, the apparatus to receive map information specifying a plurality of points of interest. The apparatus is also caused to retrieve characteristic information of the plurality of points of interest. The apparatus is further caused to generate one or more icons representing the plurality of points of interest based on the characteristic information, wherein the one or more icons are illustrated images. The apparatus is also caused to create an illustrated digital map including the illustrated images, wherein the illustrated digital map is scaled to highlight the one or more icons and to factor in size of the display. The apparatus is further caused to present the illustrated digital map via a graphical user interface on the display.

According to another embodiment, a system comprises one or more servers configured to perform receiving map information specifying a plurality of points of interest. The one or more servers are also configured to perform retrieving characteristic information of the plurality of points of interest. The one or more servers are further configured to generating one or more icons representing the plurality of points of interest based on the characteristic information, wherein the one or more icons are illustrated images. The one or more servers are also configured to creating an illustrated digital map including the illustrated images, wherein the illustrated digital map is scaled to highlight the one or more icons and to factor in display size of a device. The one or more servers are further configured to presenting the illustrated digital map via a graphical user interface.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between the service provider and mobile device with actions being performed on both sides.

For various example embodiments, the following is applicable: An apparatus comprising means for performing a method of any of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of map generation platform, according to one embodiment;

FIG. 2 is a diagram of the components of the map generation platform of FIG. 1, according to one embodiment;

FIG. 3 is a flowchart of a process for generating an illustrated map, according to one embodiment;

FIG. 4 is a diagram of an illustrated map produced by the platform of FIG. 1 and output to a graphical user interface (GUI), according to one embodiment;

FIG. 5 is a diagram of an illustrated map providing information about a point of interest, according to one embodiment;

FIGS. 6A-6C are diagrams of a 3D image produced by a mobile device, according to various embodiments;

FIG. 7 is a diagram of a virtual reality device in conjunction with a mobile device to provide a 3D image of a point of interest, according to one embodiment;

FIGS. 8A and 8B are diagrams of a mobile device employing a holographic prism to present a 3D image of a point of interest, according to one embodiment;

FIG. 9 is a diagram of hardware that can be used to implement various example embodiments;

FIG. 10 is a diagram of a chip set that can be used to implement various example embodiments; and

FIG. 11 is a diagram of a mobile device (e.g., handset) that can be used to implement various example embodiments.

### DESCRIPTION OF SOME EMBODIMENTS

Examples of a method, apparatus, and system for generating an illustrated digital map are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

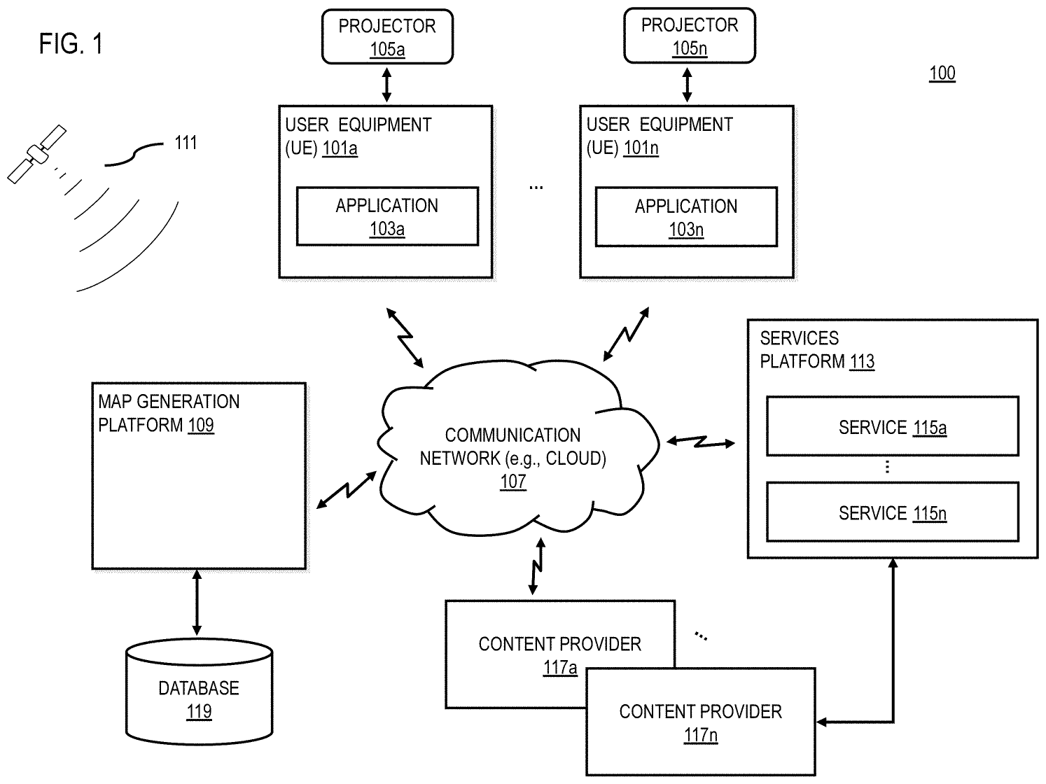

FIG. 1 is a diagram of map generation platform, according to one embodiment. As explained, the voluminous details of a tradition map or directory can overwhelm users with irrelevant information, thereby making the decision to navigate to a particular point of interest cumbersome and inefficient. To address the drawbacks of conventional systems and approaches, a system 100 of FIG. 1 includes a map generation service that introduces the capability to highlight desired points of interest as to enable the user to quickly navigate via a device, such as a smart phone. Moreover, despite the improvement in display resolution and size, displaying mapping information can be make the process of navigating to destinations slow and inefficient.

It is also recognized that users may wish to engage in commerce and determine which businesses and associated services are within a certain geographic region. This knowledge is most needed in new or uncommon geographic areas. Moreover, businesses may seek to promote their services/products. Consequently, the platform 109 can highlight the identifying characteristics of a business and display, via the generated map or, its associated logo or other unique indicia. The platform 109 may operate with other platforms that have a recommendation engine for rating and promoting businesses for generating the illustrated map or directory.

As shown in FIG. 1, the system 100 comprises user equipment (UE) 101a-101n (collectively referred to as UE 101) that may include or be associated with applications 103a-103n (collectively referred to as applications 103) and projectors 105a-105n (collectively referred to as projectors 105). The projectors 105, in one embodiment, is holographic projector (or prism) or a virtual reality (VR) device that produces 3D images and/or video in conjunction with the applications 103 of the UEs 101. In one embodiment, the UE 101 has connectivity to the map generation platform 109 via the communication network 107. The map generation platform 109 performs one or more functions associated with generating and displaying holograms of points of interest in conjunction with the UEs 101a-101n.

The platform 109 allow users to specify user preferences to permit a customized map that highlights points of interest/landmarks. The map is produced as an illustration as to be engaging and user friendly, whereby unnecessary details (e.g., intermediate street signs, address information, road segments, intersections, etc.) are not displayed. In this manner, the user advantageously can hone in on a desired destination (i.e., point of interest). According to one embodiment, once the destination is selected, more navigational details can be presented.

By way of example, the UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, a smartphone, a smartwatch, smart eyewear, or any combination thereof, including the accessories and peripherals of these devices, or any combination thereof. It is also contemplated that the UE 101 can support any type of interface to the user (such as “wearable” circuitry, etc.). In one embodiment, the UE 101 may include Global Positioning System (GPS) receivers to obtain geographic coordinates from satellites 111 for determining current location and time associated with the UE 101; such GPS information can be utilized to geo-tag images captured by the UE's camera.

The map generation platform 109 operates in conjunction with one or more applications resident on an UE 101. By way of example, the applications 103 may be any type of application that is executable at UE 101, such as content provisioning services, camera/imaging application, media player applications, social networking applications, calendar applications, and the like. In one embodiment, the applications 103 may assist in conveying mapping information via the communication network 107. In another embodiment, one of the applications 103 at the UE 101 may act as a client for the map generation platform 109 and perform one or more functions associated with the functions of the platform 109 by interacting with the platform 109 over the communication network 107.

The communication network 107 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including 5G (5^{th} Generation), 4G, 3G, 2G, Long Term Evolution (LTE), enhanced data rates for global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., worldwide interoperability for microwave access (WiMAX), code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the map generation platform 109 may be a platform with multiple interconnected components. The map generation platform 109 may include multiple servers, intelligent networking devices, computing devices, components and corresponding software for providing real-time feedback based, at least in part, on analysis of sensor information. In addition, it is noted that the map generation platform 109 may be integrated or separated from services platform 113. Also, certain functionalities of the system 109 may reside within the UE 101 (e.g., as part of the applications 103).

As shown in FIG. 1, the system 109 can interface a services platform 113, which provides various services, such as notification services, content (e.g., audio, video, images, etc.) provisioning services, application services, storage services, contextual information determination services, social networking services, location-based services, information-based services, etc. In one embodiment, the services platform 113 may interact with the UE 101, the map generation platform 109 and the content provider 117 to supplement or aid in the processing of the content information.

In the embodiment of FIG. 1, content providers 117a-117n (collectively referred to as content provider 117) may provide content to the UE 101, the map generation platform 109, and the services 115 of the services platform 113. The content provided may be any type of content, such as image content (e.g., pictures), textual content, audio content, video content, etc. In one embodiment, the content provider 117 may provide content that may supplement the content of the applications 103, the projectors 105, or a combination thereof. In another embodiment, the content provider 117 may also store content associated with the UE 101, the map generation platform 109, and the services 115 of the services platform 113. In a further embodiment, the content provider 117 may manage access to a central repository of data and offer a consistent, standard interface to data.

Associated with the map generation platform 109 is database 119. It is contemplated that database 119 can be implemented as a cloud storage system. In one embodiment, the database 119 stores mapping data, the generated illustrated maps, as well as user/subscriber profile information.

By way of example, UE 101, the map generation platform 109, the services platform 113, and the content provider 117 communicate with each other and other components of the communication network 107 using well known, new or still developing protocols (e.g., IoT standards and protocols). In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

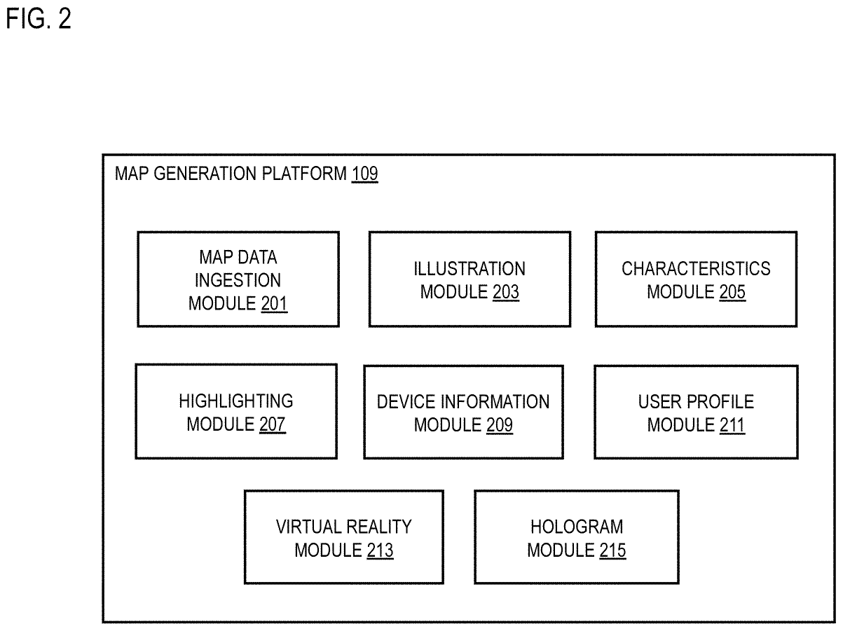

FIG. 2 is a diagram of the components of the map generation platform of FIG. 1, according to one embodiment. By way of example, the platform 109 includes one or more components for generating and displaying an illustrated map with highlighted points of interest. It is contemplated that the functions of these components may be combined in one or more components or performed by other components of equivalent functionality. In this embodiment, the map generation platform 109 includes the following modules: a map data ingestion module 201, an illustration module 203, a characteristics module 205, a highlighting module 207, a device information module 209, a user profile module 211, a virtual reality module 213, and a hologram module 215.

A map data ingestion module 201 collects mapping information from one or more mapping services to maintain the latest mapping information (e.g., road segments, road signs, streets, intersections, addresses, geo-coordinates, etc.). The mapping information may be for both external geographic areas as well as indoor mapping information (e.g., shopping mall, office buildings, apartment complexes, etc.). The ingestion process can be periodic or on-demand. It is contemplated that the mapping information pertains to all areas within the world, to the extent such information can be collected. Optionally, the mapping information can be acquired and/or verified through other sources, such as social media and services by the services platform 113.

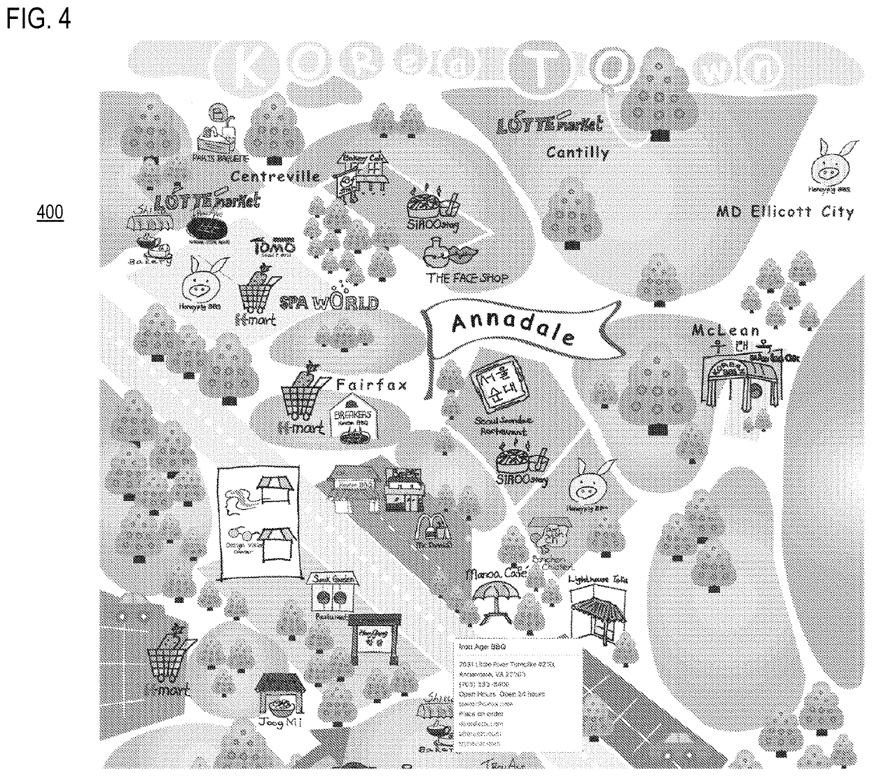

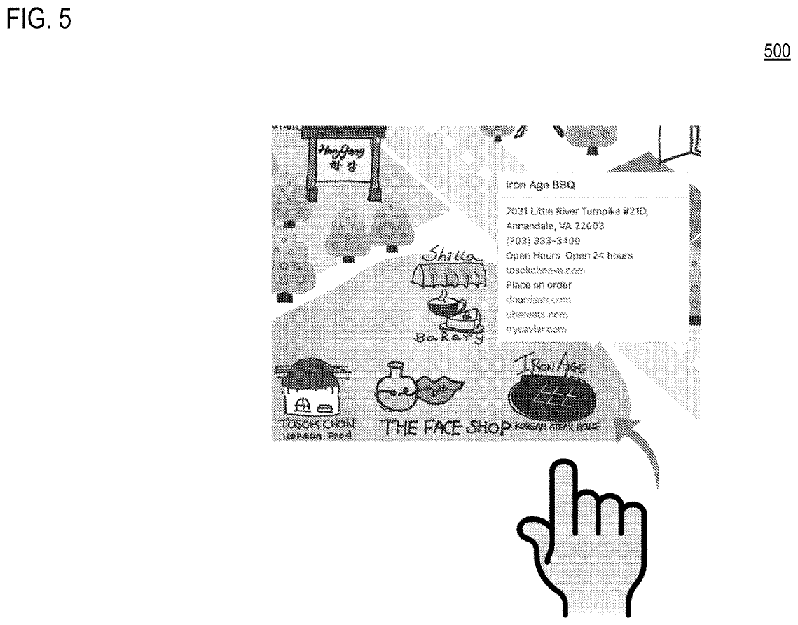

The illustration module 203 operates upon images and information from the characteristics module 205 to produce non-realistic renderings of images of points of interest (e.g., landmarks, buildings, etc.)—as shown in FIGS. 4 and 5. That is, the characteristics modules 205 obtains photo images of points of interest based on the ingested map data from the map data ingestion module 201. From the photo images, the characteristics modules 205 extracts identifying information or indicia of the points of interest. Such indicia may include appearance of the point of interest, or any identifying information about the point of interest (e.g., color of the building, size of the building, etc.). For example, if the point of interest is a business, the indicia can be the logo or color scheme associated with the business. In one embodiment, the characteristic information is unique to the point of interest; such that the user can quickly identify a particular point of interest among other points of interest within the illustrated map. Characteristic information can be textual or visual information, and include meta data (e.g., associated with a photo).

The platform 109 utilizes the highlighting module 207 to select a particular icon corresponding to a point of interest to emphasis within the illustrated map. For instance, the highlighting of the icon can be to bring the icon to the foreground by dimming or fading the background; alternatively, the icon can simply be brightened through brightness, contrast, or color adjustment. That is, such highlighting can be in form of brightness as well as color; such as overlaying a more vibrant color on the subject icon. Also, the background can be blurred. According to one embodiment, the highlighting module 207 communicates with the user profile module 211 to obtain user preference information that will indicate which icon(s) to highlight. For example, the user may have a preference for seeing all museums within a particular locale such that upon entering the area, all icons representing museums are highlighted. In this manner, the user can readily be notified of points of interest that are customized to the user's preferences. The user profile module 211 can also acquire and store other information about the user that may or may not be relevant to the particular icons—e.g., account information, home address, work address, contact lists, etc.

The platform 109 generates the illustrated map by considering the display size of the operating device through the device information module 209. This module 209 gathers information about the device that the user is utilizing to display the illustrated map. The display size information is then employed to scale the illustrated map to display relevant icons according to a relative scale (versus the actual scale) so that the user can easily navigate the illustrated to view the desired points of interest.

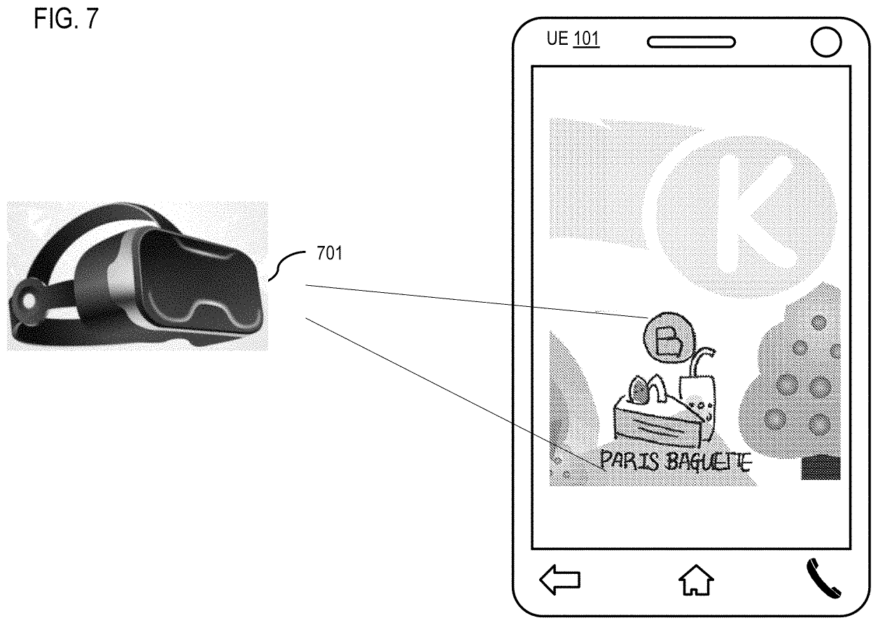

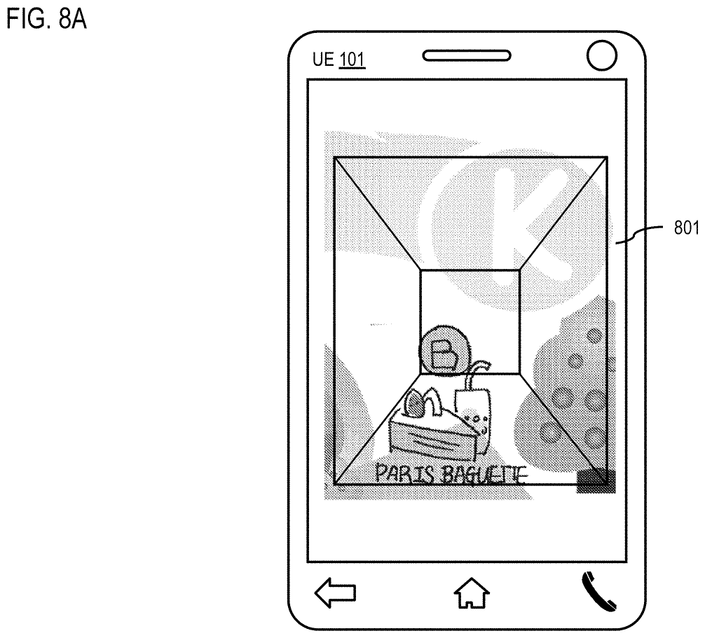

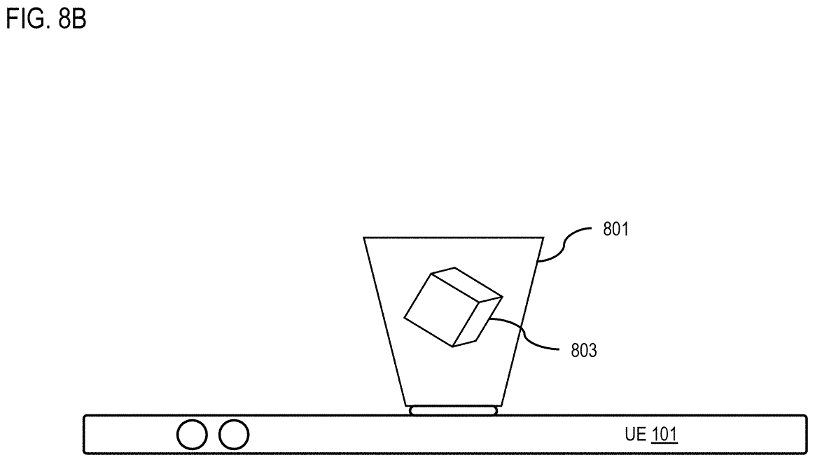

Additionally, the highlighting module 207 operates in conjunction with the virtual reality module 213 and the hologram module 215. The virtual reality module 213 converts the highlight icon into a 3D image that can be viewed through a virtual reality goggle, for example as depicted in FIG. 7. In addition or in lieu of, the hologram module 215 can convert the icon into a 3D hologram for viewing via a hologram projector, such as a hologram prism (FIGS. 8A and 8B).

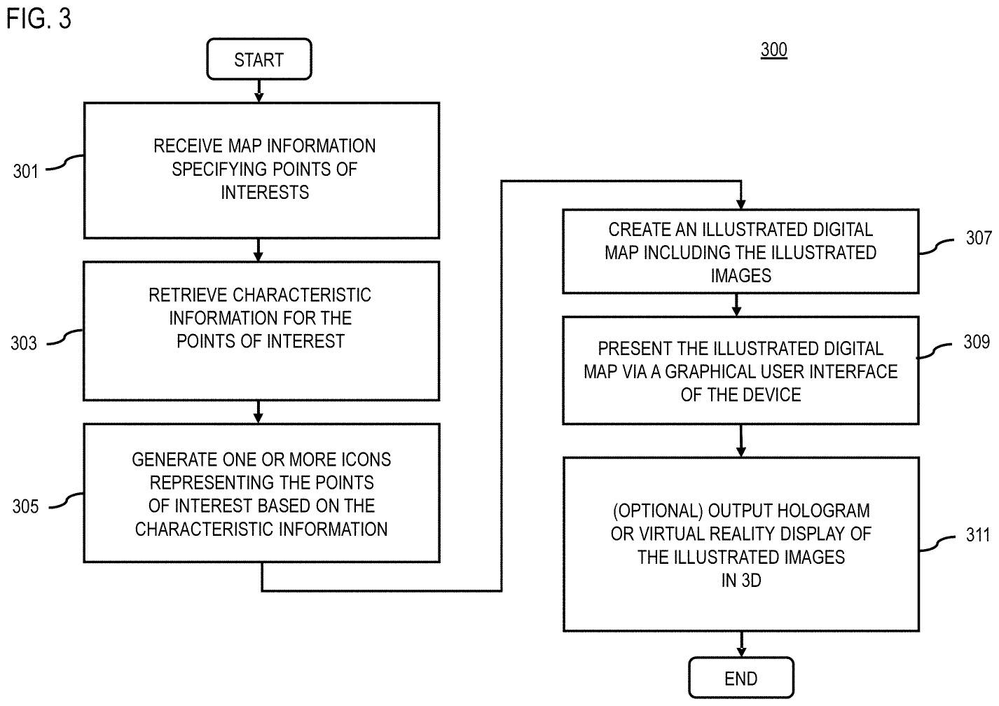

The above presented modules and components of the map generation platform 109 can be implemented in hardware, firmware, software, or a combination thereof. Though depicted as a separate entity in FIG. 1, it is contemplated that the map generation platform 109 may be implemented for direct operation by respective UE 101. As such, the map generation platform 109 may generate direct signal inputs by way of the operating system of the UE 101 for interacting with the applications 103. In another embodiment, one or more of the modules of FIG. 2 and process of FIG. 3 may be implemented for operation by respective UEs, the map generation platform 109, or combination thereof. Still further, the map generation platform 109 may be integrated for direct operation with services 115, such as in the form of a widget or applet, in accordance with an information and/or subscriber sharing arrangement. The various executions presented herein contemplate any and all arrangements and models.

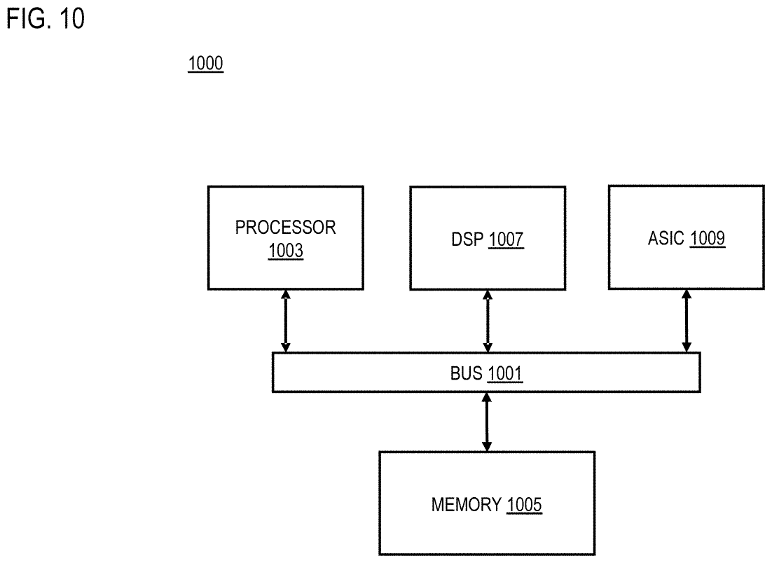

FIG. 3 is a flowchart of a process for generating an illustrated map, according to one embodiment. In one embodiment, the map generation platform 109 performs the process 300 and is implemented in, for instance, a chip set including a processor and a memory as shown in FIG. 10. In step 301, the platform 109 receives map information specifying a plurality of points of interest. In step 303, characteristic information of the points of interest is retrieved. In one embodiment, the points of interest include business entities (e.g., restaurants, offices, museums, universities, etc.). The characteristic information of the plurality of points of interest is based on an indicia associated with the points of interest. As explained, the indicia can be any identifying information; for instance, for a business, the indicia can include the logo or color scheme of the business. In one embodiment, the characteristic information are unique among the plurality of points of interest. The platform 109 generates one or more icons representing the points of interest based on the characteristic information (per step 305), wherein the one or more icons are illustrated images. In step 307, the platform 109 creates an illustrated digital map including the illustrated images. The illustrated digital map is scaled to highlight the one or more icons and to factor in display size of a device (e.g., UE 101a). The platform 109, per step 309, presents the illustrated digital map via a graphical user interface (GUI) of the UE 101a. Optionally, the platform 109 converts the one or more icons into a 3D rendering for display as a hologram or virtual reality, per step 311. Optionally, the platform 109 can utilize user preference information relating to the points of interest to produce the illustrated map, wherein the highlighted one or more icons are based on the user preference information.

Furthermore, the platform 109 may present certain business information (associated with an icon, as shown in FIG. 5 in form of a text box, which specifies information about the place of business such as address, telephone, hours of operation, etc.) on the illustrated digital map within proximity of the corresponding one or more icons

FIG. 4 is a diagram of an illustrated map produced by the platform of FIG. 1 and output to a graphical user interface (GUI), according to one embodiment. As shown, the illustrated map 400 is in form of a non-realistic representation that is engaging and easier to determine points of interest. The non-realistic aesthetics provide a more user friendly interface, notably for younger users.

FIG. 5 is a diagram of an illustrated map providing information about a point of interest, according to one embodiment. As shown in screen 500, information about a particular point interest can be displayed upon selection of a corresponding icon on the illustrated map. It is contemplated that any information can be presented; for example, if the business has a promotion, such promotional information can be displayed for the duration of the promotion. That is, the information can be dynamic.

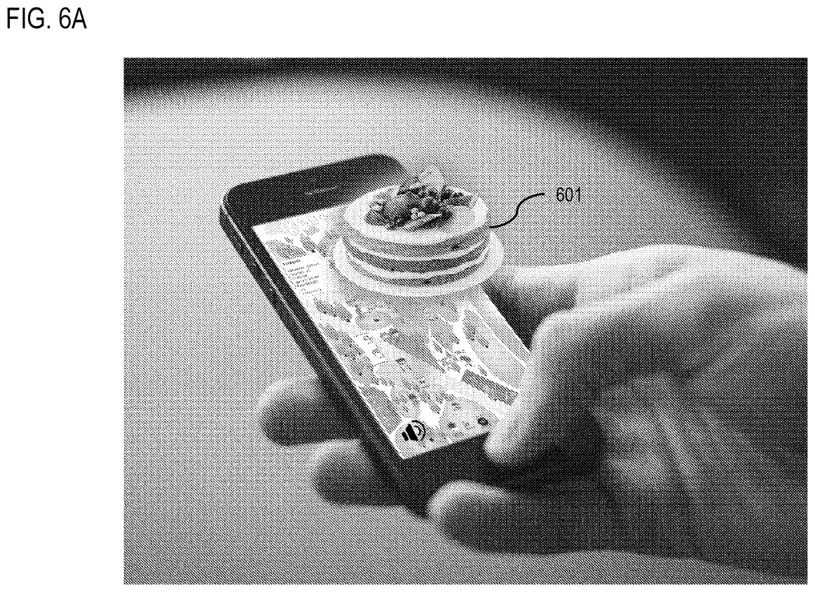

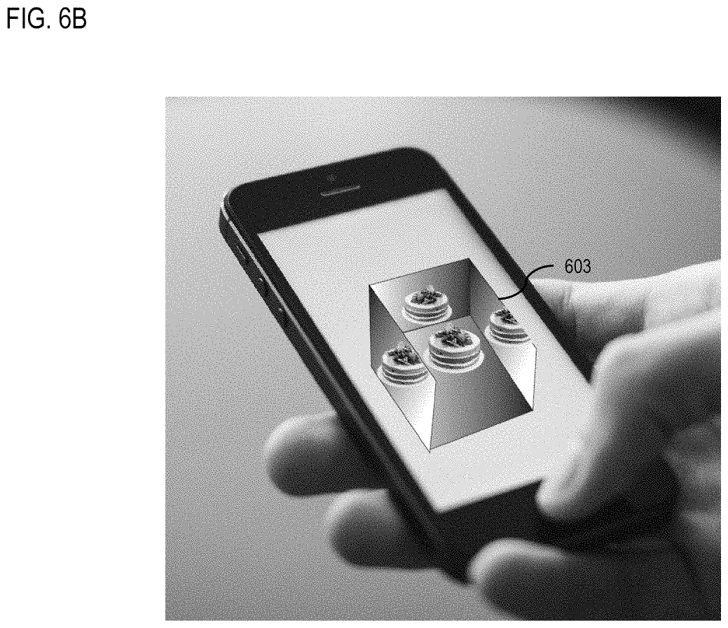

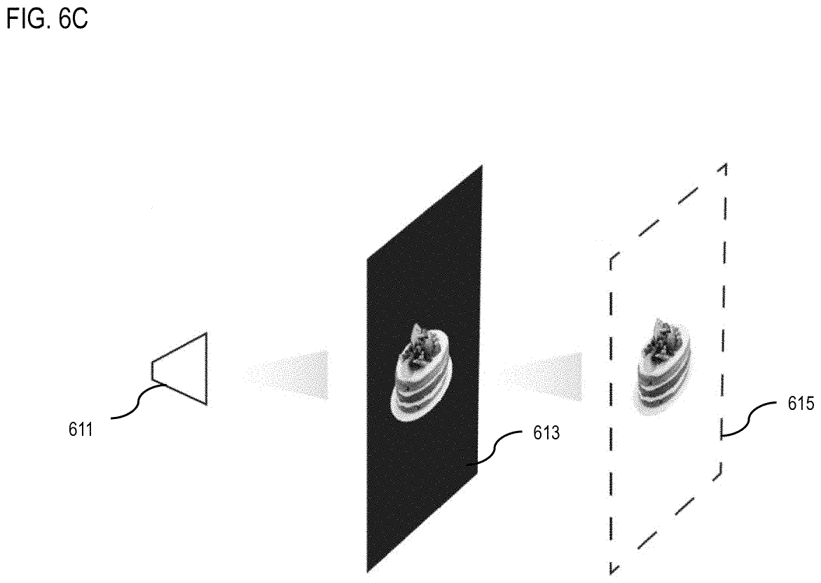

FIG. 6A is a diagram of a 3D image produced by a mobile device in conjunction with a hologram projector or a virtual reality device, according to one embodiment. The 3D image 601 can be displayed via a virtual reality goggle (as in shown in FIG. 7), or through a hologram projector (e.g., projector 105) as shown in FIGS. 8A and 8B. FIG. 6B illustrates use of a mirror filter 603 that can be temporarily affixed to the display of the mobile device; the filter 603 produces a 3D effect equivalent to a hologram. By way of example, the mirror filter 603 has a silver mercury color that is created using RGB primary colors. FIG. 6C shows how a hologram can be produced, according to one embodiment. Under this scenario, a projector 611 can be integrated into a mobile device, e.g., UE 101, which employs a display filter 613 to isolate the subject icon (e.g., the cake) from the background. It is noted that the display filter 613 can be implemented digitally; for example, the filter 613 can be an adjustable RBG filter. The subject icon can then be projected onto a transparent screen 615 can is situated above the display of the UE 101.

FIG. 7 is a diagram of a virtual reality device in conjunction with a mobile device to provide a 3D image of a point of interest, according to one embodiment. In this scenario, a user is equipped with a virtual reality goggle 701, which operates in conjunction with the application 103 of UE 101. The application 103 communicates with the map generation platform 109 to determine which icon is to be converted and displayed in 3D form. It is contemplated that any state of the art VR goggle may be utilized.

FIGS. 8A and 8B are diagrams of a mobile device employing a holographic prism to present a 3D image of a point of interest, according to one embodiment. A hologram projector 801 in form of a hologram prism is affixed to the display screen of UE 101. The side view, as seen in FIG. 8B, reveals how a 3D hologram 803 can be displayed within the hologram prism 801. The 3D hologram 803 represents the highlight icon. It is contemplated that any state of the art hologram projector can be utilized; e.g., Spectre™ hologram smartphone product. Additionally, it is contemplated that a hologram projector may be integrated with the UE 101.

The processes described herein for generating an illustrated digital map may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

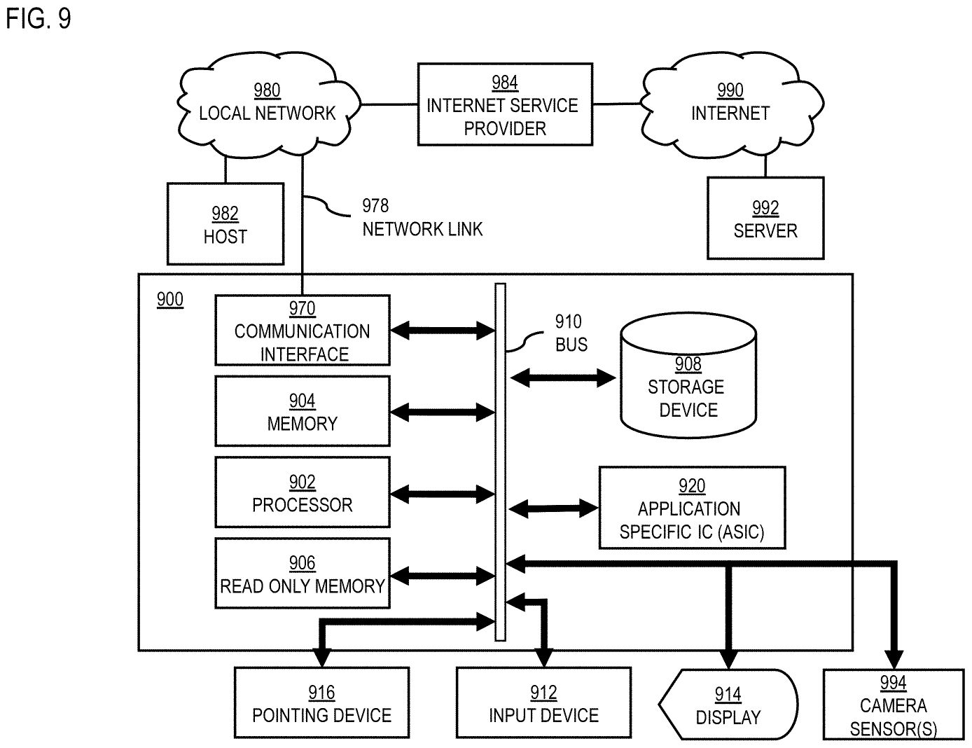

FIG. 9 illustrates a computer system 900 upon which various embodiments of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to dispatch in support of services or delivery of goods as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of the processes described herein, including that of FIG. 3.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to enhancing class participation. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 900 also includes a memory 904 coupled to bus 910. The memory 904, such as a random access memory (RANI) or any other dynamic storage device, stores information including processor instructions for generating an illustrated digital map. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for generating an illustrated digital map, is provided to the bus 910 for use by the processor from an external input device 912, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a vacuum fluorescent display (VFD), a liquid crystal display (LCD), a light-emitting diode (LED), an organic light-emitting diode (OLED), a quantum dot display, a virtual reality (VR) headset, a plasma screen, a cathode ray tube (CRT), or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914, and one or more camera sensors 994 for capturing, recording and causing to store one or more still and/or moving images (e.g., videos, movies, etc.) which also may comprise audio recordings. In some embodiments, for example, in embodiments in which the computer system 900 performs all functions automatically without human input, one or more of external input device 912, a display device 914 and pointing device 916 may be omitted.

In the illustrated embodiment, special purpose hardware, such as an application specific integrated circuit (ASIC) 911, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners, and external disks. In general, the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 97 for generating an illustrated digital map.

The term “computer-readable medium” as used herein refers to any medium that participates in providing information to processor 902, including instructions for execution. Such a medium may take many forms, including, but not limited to a computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 911.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 911, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which various embodiments of the invention may be implemented. Chip set 1000 is programmed to generate an illustrated digital map as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of enhancing class participation.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to provide enhancing class participation. The memory 1005 also stores the data associated with or generated by the execution of the inventive steps.

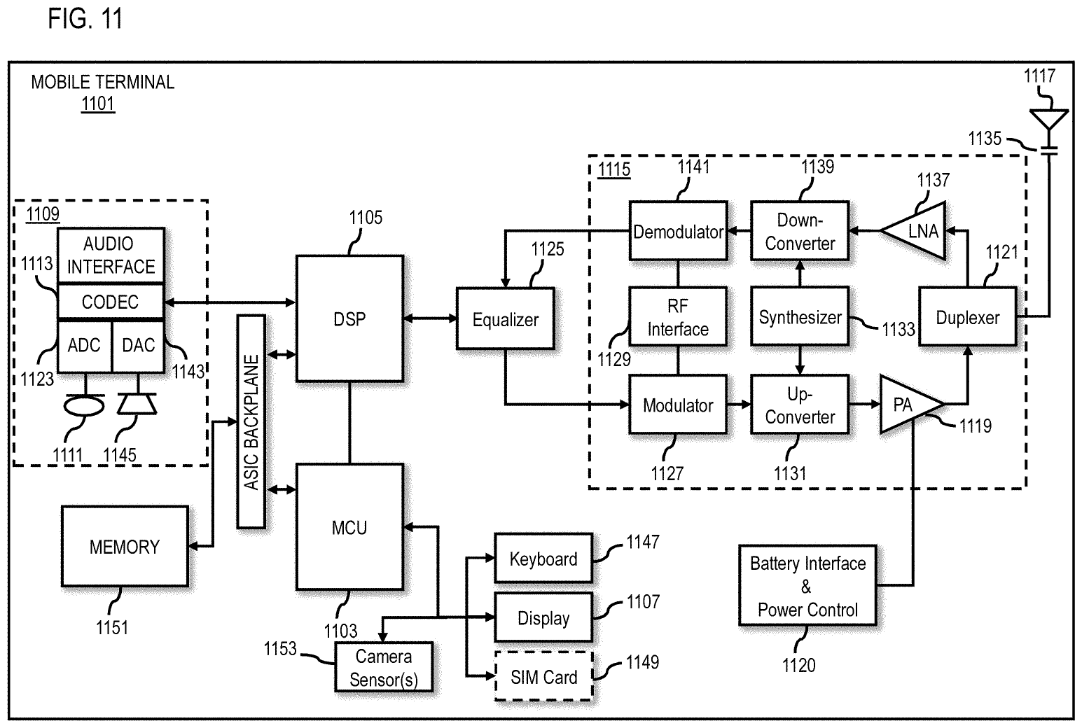

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of enhancing class participation. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of enhancing class participation. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies the power and converts frequency in order to communicate with a base station, which is included in a mobile communication system, via antenna 1117. The power amplifier (PA) 1110 and the transmitter/modulation circuitry are operationally responsive to the MCU 1103, with an output from the PA 1110 coupled to the duplexer 1121 or circulator or antenna switch, as known in the art. The PA 1110 also couples to a battery interface and power control unit 1111.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with an RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1110 to increase the signal to an appropriate power level. In practical systems, the PA 1110 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to provide enhancing class participation. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

Further, one or more camera sensors 1153 may be incorporated onto the mobile station 1101 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving map information specifying a plurality of points of interest;
retrieving characteristic information of the plurality of points of interest;
generating one or more icons representing the plurality of points of interest based on the characteristic information, wherein the one or more icons are illustrated images;
creating an illustrated digital map including the illustrated images, wherein the illustrated digital map is scaled to highlight the one or more icons and to factor in display size of a device; and
presenting the illustrated digital map via a graphical user interface of the device.

2. The method of claim 1, wherein the points of interest include business entities, the method further comprising:
determining the characteristic information of the plurality of points of interest based on an indicia associated with the points of interest, wherein the characteristic information are unique among the plurality of points of interest.

3. The method of claim 2, wherein the indicia includes a color scheme or a logo, the method further comprising:
retrieving business information for business entities; and
presenting the business information on the illustrated digital map within proximity of the corresponding one or more icons.

4. The method of claim 1, further comprising:
receiving user preference information relating to the points of interest, wherein the highlighted one or more icons are based on the user preference information.

5. The method of claim 1, further comprising:
converting the one or more icons into a 3D image for presentation via a virtual reality display.

6. The method of claim 1, further comprising:
converting the one or more icons into a 3D image for presentation as a hologram.

7. The method of claim 6, further comprising:
outputting the hologram via a projector of a mobile device, wherein the mobile device includes a smart phone or a tablet.

8. An apparatus comprising:
at least one processor;
a display; and
at least one memory including computer program code for one or more programs, the at least one memory and the computer program code configured to, with the at least one processor, cause the apparatus to perform at least the following:
receive map information specifying a plurality of points of interest;
retrieve characteristic information of the plurality of points of interest;
generate one or more icons representing the plurality of points of interest based on the characteristic information, wherein the one or more icons are illustrated images;
create an illustrated digital map including the illustrated images, wherein the illustrated digital map is scaled to highlight the one or more icons and to factor in size of the display; and
present the illustrated digital map via a graphical user interface on the display.

9. The apparatus of claim 8, wherein the points of interest include business entities, and the apparatus is further caused to:
determine the characteristic information of the plurality of points of interest based on an indicia associated with the points of interest, wherein the characteristic information are unique among the plurality of points of interest.

10. The apparatus of claim 9, wherein the indicia includes a color scheme or a logo, and the apparatus is further caused to:
retrieve business information for business entities; and
present the business information on the illustrated digital map within proximity of the corresponding one or more icons.

11. The apparatus of claim 8, wherein the apparatus is further caused to:
receive user preference information relating to the points of interest, wherein the highlighted one or more icons are based on the user preference information.

12. The apparatus of claim 8, wherein the apparatus is further caused to:
convert the one or more icons into a 3D image for presentation via a virtual reality display.

13. The apparatus of claim 8, wherein the apparatus is further caused to:
convert the one or more icons into a 3D image for presentation as a hologram.

14. The apparatus of claim 14, wherein the apparatus is further caused to:
output the hologram via a projector of a mobile device, wherein the mobile device includes a smart phone or a tablet.

15. A system comprising:
one or more servers configured to perform:
receiving map information specifying a plurality of points of interest;
retrieving characteristic information of the plurality of points of interest;
generating one or more icons representing the plurality of points of interest based on the characteristic information, wherein the one or more icons are illustrated images;
creating an illustrated digital map including the illustrated images, wherein the illustrated digital map is scaled to highlight the one or more icons; and
presenting the illustrated digital map via a graphical user interface.

16. The system of claim 15, wherein the points of interest include business entities, and the one or more servers are further configured to perform:
determining the characteristic information of the plurality of points of interest based on an indicia associated with the points of interest, wherein the characteristic information are unique among the plurality of points of interest; and
receiving display size information for a device configured to present the graphical user interface, wherein the scaling is further based on the display size information.

17. The system of claim 16, wherein the indicia includes a color scheme or a logo, and the one or more servers are further configured to perform:
retrieving business information for business entities; and
presenting the business information on the illustrated digital map within proximity of the corresponding one or more icons.

18. The system of claim 15, wherein the one or more servers are further configured to perform:
receiving user preference information relating to the points of interest, wherein the highlighted one or more icons are based on the user preference information.

19. The system of claim 15, wherein the one or more servers are further configured to perform:
converting the one or more icons into a 3D image for presentation via a virtual reality display.

20. The system of claim 15, wherein the one or more servers are further configured to perform:
converting the one or more icons into a 3D image for presentation as a hologram; and
outputting the hologram via a projector of a mobile device, wherein the mobile device includes a smart phone or a tablet.
